(19) United States
(12) Patent Application Publication
(10) Pub. No.: US 2026/0134091 A1
(43) Pub. Date: May 14, 2026

(54) Continuous Monitoring with Compact System Representations to Detect Advanced Persistent Threats

(71) Applicant: Virginia Tech Intellectual Properties, Inc., Blacksburg, VA (US)

(72) Inventors: Danfeng Yao, Blacksburg, VA (US); Wenjia Song, Blacksburg, VA (US)

(21) Appl. No.: 19/382,412

(22) Filed: Nov. 7, 2025

Related U.S. Application Data
(60) Provisional application No. 63/718,297, filed on Nov. 8, 2024.

(51) Int. Cl. G06F 21/55; G06N 20/00

(52) U.S. Cl. CPC G06F 21/552; G06N 20/00

(57) ABSTRACT

Advanced persistent threats (APTs) have caused significant financial losses for enterprises, making the development of effective detection systems a critical priority. While existing provenance graph-based APT defenses demonstrate high accuracy, the high complexity and cost of graph operations (e.g., construction, iteration) require extensive processing time and computational resources, making them impractical for real-time detection. To address this challenge, we introduce Madeline, a graph-free, lightweight APT detection system that leverages historical system statistics. This graph-free statistical approach enables lightweight coarse-grained detection with minimal computational resources. Through a multi-step state score calculation for a set of behavioral attributes, Madeline meticulously captures subtle, gradual system changes indicative of stealthy APT activities. Using an unsupervised LSTM autoencoder, Madeline performs anomaly detection effectively without the need for prior knowledge or manual labeling of attacks. Additionally, Madeline supports continuous monitoring, enhancing the assessment of ongoing risks.

### CROSS-REFERENCE TO RELATED APPLICATIONS

The present application relies on the disclosure of and claims priority to and the benefit of the filing date of U.S. Provisional Patent Application No. 63/718,297, filed Nov. 8, 2024, which application is hereby incorporated by reference herein in its entirety.

### STATEMENT OF GOVERNMENT INTEREST

This invention was made with government support under Grant No. N00014-22-1-2057 awarded by the United States Office of Naval Research. The government has certain rights in the invention.

### BACKGROUND OF THE INVENTION

### Field of the Invention

The present invention relates to the field of advanced persistent threat (APT) detection. More specifically, embodiments include methods and systems employing machine learning techniques and models to detect deviations of a system's behavior from normally distributed events and actions.

### Description of Related Art

Advanced persistent threats (APTs) have shown a notable escalation, causing unprecedented damage. For example, the campaign conducted by Lazarus group in 2016 caused an 81 million dollar loss for the Central Bank of Bangladesh (Alam, N. The great Bangladesh cyber heist shows truth is stranger than fiction, Dhaka Tribune, Mar. 12, 2016). APTs have also been responsible for significant data breaches across various organizations, including Equifax (Equifax Data Breach Settlement, J N D, 2024) and the Personnel Management for the federal government (Koerner, B. Inside the Cyberattack That Shocked the US Government, WIRED Security, Oct. 23, 2016). To defend against such threats, detections using system audit logs have been widely developed to catch malicious behaviors going on in the system (Cheng, Z. et al., KAIROS: Practical Intrusion Detection and Investigation using Whole-system Provenance. In 2024 IEEE Symposium on Security and Privacy (SP). 5-5; Han, X. et al., 2020. UNICORN: Runtime Provenance-Based Detector for Advanced Persistent Threats. In Proceedings of Symposium on Network and Distributed System Security (NDSS)).

System audit logs record various ongoing tasks and are great sources for threat hunting. The most popular APT detection approach is to derive a provenance graph from audit logs to analyze the causality of events. Provenance graphs depict system execution using system entities (e.g., processes, files) as nodes and actions (e.g., open, read) as edges. The dependency relationships between events can be inferred from the graph. The extracted information is then used to detect malicious behaviors at the edge or subgraph level, using signature matching (Hassan, W. U. et al., Tactical provenance analysis for endpoint detection and response systems. In 2020 IEEE Symposium on Security and Privacy (SP). IEEE, 1172-1189; Hossain, M. N. et al., Combating dependence explosion in forensic analysis using alternative tag propagation semantics. In 2020 IEEE Symposium on Security and Privacy (SP). IEEE, 1139-1155; Milajerdi, S. M. et al., Poirot: Aligning attack behavior with kernel audit records for cyber threat hunting. In Proceedings of the 2019 ACM SIGSAC conference on computer and communications security. 1795-1812; Milajerdi, S. M. et al., HOLMES: Real-Time APT Detection through Correlation of Suspicious Information Flows. In 2019 IEEE Symposium on Security and Privacy (SP). 1137-1152; Xie, Y. et al., Pagoda: A hybrid approach to enable efficient real-time provenance based intrusion detection in big data environments. IEEE Transactions on Dependable and Secure Computing 17, 6 (2018), 1283-1296; Xie, Y. et al., P-gaussian: provenance based gaussian distribution for detecting intrusion behavior variants using high efficient and real time memory databases. IEEE Transactions on Dependable and Secure Computing 18, 6 (2019), 2658-2674; Xiong, C. et al., CONAN: A practical real-time APT detection system with high accuracy and efficiency. IEEE Transactions on Dependable and Secure Computing 19, 1 (2020), 551-565) or learning-based methods (Cheng, 2024; Han, 2020; Hassan, W. U. et al., 2019, Nodoze: Combatting threat alert fatigue with automated provenance triage. In Proceedings of Symposium on Network and Distributed System Security (NDSS); Hassan, W. U. et al., 2020, This is why we can't cache nice things: Lightning-fast threat hunting using suspicion based hierarchical storage. In Proceedings of the 36th Annual Computer Security Applications Conference. 165-178; Liu, Y. et al., 2018, Towards a Timely Causality Analysis for Enterprise Security. In Proceedings of Symposium on Network and Distributed System Security (NDSS); Rehman, M. U. et al., FLASH: A Comprehensive Approach to Intrusion Detection via Provenance Graph Representation Learning. In 2024 IEEE Symposium on Security and Privacy (SP). IEEE Computer Society, 139-139; Wang, Q. et al., 2020, You Are What You Do: Hunting Stealthy Malware via Data Provenance Analysis. In Proceedings of Symposium on Network and Distributed System Security (NDSS); Yang, F. et al., 2023, PROGRAPHER: An Anomaly Detection System based on Provenance Graph Embedding. In 32nd USENIX Security Symposium (USENIX Security 23). USENIX Association, Anaheim, CA, 4355-4372; Dong, F. et al., DISTDET: A Cost-Effective Distributed Cyber Threat Detection System. In 32nd USENIX Security Symposium (USENIX Security 23), 2023, 6575-6592; Wang, S. et al., Threatrace: Detecting and tracing hostbased threats in node level through provenance graph learning. IEEE Transactions on Information Forensics and Security 17 (2022), 3972-3987; Zeng, J. et al., Shadewatcher: Recommendation-guided cyber threat analysis using system audit records. In 2022 IEEE Symposium on Security and Privacy (SP). IEEE, 489-506). For instance, HOLMES (Milajerdi, 2019) summarizes known attack patterns and flags any matching behaviors. Unicorn (Han, 2020) identifies abnormal system execution state through encoded provenance graphs.

However, while achieving promising accuracy, graph-based analysis is also known to be complex and time-consuming (Liu, 2018). The reason is that analyses need to be done at a fine-grained event level. Excessive investigative time and resources are required to trace the relevant and complex context of an event. As the system logs accumulate, the sizes of the provenance graphs increase substantially, taking a considerable amount of memory space (over 13 GB in these experiments). Recent research has shown that graph generation accounts for more than 96% of the time required for attack analysis (Ding, H. et al., 2023, AIRTAG: Towards Automated Attack Investigation by Unsupervised Learning with Log Texts. In 32nd USENIX Security Symposium (USENIX Security 23). 373-390), posing a big challenge to prompt threat detection.

Specifically, some works use graph or event statistics. NoDoze (Hassan, 2019) computes an anomaly score for every node along a dependency path based on their occurrence frequencies. Unicorn (Han, 2020) converts counts of system provenance subgraphs to a system state representation to detect any outliers. P-gaussian (Xie, 2019) uses Gaussian distribution to describe attack sequences and identify similar suspicious behaviors. Other APT defense works include network-level approaches (Bajaber, O. et al., P4Control: Line-Rate Cross-Host Attack Prevention via In-Network Information Flow Control Enabled by Programmable Switches and eBPF. In 2024 IEEE Symposium on Security and Privacy (SP). IEEE Computer Society, 147-147; Ji, Y. et al., 2018, Enabling refinable {Cross-Host} attack investigation with efficient data flow tagging and tracking. In 27th USENIX Security Symposium (USENIX Security 18). 1705-1722).

Attack investigation happens after the detection of attacks in order to gain intelligence of the attack, clear threats in the system, and help strengthen the protection. Most investigation works focus on analyzing the causality of events using provenance graphs (Alsaheel, A. et al., 2021, ATLAS: A sequence-based learning approach for attack investigation. In 30th USENIX security symposium (USENIX security 21). 3005-3022; Gao, P. et al., AIQL: Enabling efficient attack investigation from system monitoring data. In 2018 USENIX Annual Technical Conference (USENIX ATC 18). 113-126; Hossain, M. N. et al., 2017, SLEUTH: Real-time attack scenario reconstruction from COTS audit data. In 26th USENIX Security Symposium (USENIX Security 17), 487-504; Liu, 2019; Pei, K. et al., 2016, Hercule: Attack story reconstruction via community discovery on correlated log graph. In Proceedings of the 32Nd Annual Conference on Computer Security Applications. 583-595).

Recent research also uses natural language processing (NLP) methods to track and recover the attack story (Ding, 2023; Gao, P. et al., Enabling efficient cyber threat hunting with cyber threat intelligence. In 2021 IEEE 37th International Conference on Data Engineering (ICDE). IEEE, 193-204; Nedelkoski, S. et al., Self-attentive classification-based anomaly detection in unstructured logs. In 2020 IEEE International Conference on Data Mining (ICDM). IEEE, 1196-1201; Shen, Y. and Stringhini, G., 2019, {ATTACK2VEC}: Leveraging temporal word embeddings to understand the evolution of cyberattacks. In 28th USENIX Security Symposium (USENIX Security 19). 905-921).

Studies have also been done on provenance graph reduction to save investigative efforts (Fang, P. et al., 2022, {BackPropagating} System Dependency Impact for Attack Investigation. In 31st USENIX Security Symposium (USENIX Security 22). 2461-2478; Tang, Y. et al., Nodemerge: Template based efficient data reduction for big-data causality analysis. In Proceedings of the 2018 ACM SIGSAC Conference on Computer and Communications Security. 1324-1337; Van Ede, T. et al., Deepcase: Semi-supervised contextual analysis of security events. In 2022 IEEE Symposium on Security and Privacy (SP). IEEE, 522-539; Xu, Z. et al., Depcomm: Graph summarization on system audit logs for attack investigation. In 2022 IEEE Symposium on Security and Privacy (SP). IEEE, 540-557; Xu, Z. et al., High fidelity data reduction for big data security dependency analyses. In Proceedings of the 2016 ACM SIGSAC conference on computer and communications security. 504-516; Zeng, J. et al., 2021, WATSON: Abstracting Behaviors from Audit Logs via Aggregation of Contextual Semantics) and on effective logging systems to reduce overhead (Ding, H. et al., 2021, {ELISE}: A storage efficient logging system powered by redundancy reduction and representation learning. In 30th USENIX Security Symposium (USENIX Security 21). 3023-3040; Ding, H. et al., 2023, The case for learned provenance graph storage systems. In 32nd USENIX Security Symposium (USENIX Security 23). 3277-3294; Hassan, W. U. et al., 2018, Towards scalable cluster auditing through grammatical inference over provenance graphs. In Network and Distributed Systems Security Symposium; Ma, S. et al., 2016, Protracer: Towards practical provenance tracing by alternating between logging and tainting. In 23rd Annual Network And Distributed System Security Symposium (NDSS 2016)).

Besides attack analysis, anomaly detection has also been developed for other types of logs to identify task failures or system errors. Sequential and NLP-based solutions are widely used in this field (Chen, Z. et al., 2021, Experience report: Deep learning-based system log analysis for anomaly detection. arXiv preprint arXiv:2107.05908; Cheng, Q. et al., Logai: A library for log analytics and intelligence. arXiv preprint arXiv:2301.13415 (2023); Du, 2017; Guo, H. et al., Logbert: Log anomaly detection via bert. In 2021 international joint conference on neural networks (IJCNN). IEEE, 1-8; Lee, Y. et al., Lanobert: System log anomaly detection based on bert masked language model. Applied Soft Computing 146 (2023), 110689; Meng, W. et al., 2019, Loganomaly: Unsupervised detection of sequential and quantitative anomalies in unstructured logs. In IJCAI, Vol. 19. 4739-4745; Zhang, X. et al., Robust log-based anomaly detection on unstable log data. In Proceedings of the 2019 27th ACM joint meeting on European software engineering conference and symposium on the foundations of software engineering. 807-817).

Researchers also use autoencoders to reconstruct features for anomaly detection (Farzad, A. and Gulliver T. A., Unsupervised log message anomaly detection. ICT Express 6, 3 (2020), 229-237).

Previous applications of LSTM autoencoder fall in the field of video reconstruction (Srivastava, N. et al., 2015, Unsupervised learning of video representations using lstms. In International conference on machine learning. PMLR, 843-852). Recent researchers apply it to detect anomalies in network traffic (Ashraf, J. et al., Novel Deep Learning-Enabled LSTM Autoencoder Architecture for Discovering Anomalous Events From Intelligent Transportation Systems. IEEE Transactions on Intelligent Transportation Systems 22, 7 (2021), 4507-4518; Homayouni, H. et al., An Autocorrelation-based LSTM-Autoencoder for Anomaly Detection on Time-Series Data. In 2020 IEEE International Conference on Big Data (Big Data). 5068-5077; Elsayed, M. S. et al., 2020, Network Anomaly Detection Using LSTM Based Autoencoder. In Proceedings of the 16th ACM Symposium on QoS and Security for Wireless and Mobile Networks (Alicante, Spain) (Q2SWinet '20). 37-45).

Embodiments of the present invention address the shortcomings of existing approaches in the following ways, including by adopting a different graph-free statistical approach, enabling lightweight coarse-grained detection with minimal computational resources. Embodiments of the invention can be used along with existing systems as the first layer of attack detection. In embodiments of the invention an LSTM autoencoder is applied to reconstruct the system state in a more complex APT detection scenario. Also different from existing approaches, embodiments of the present invention reconstruct preprocessed system state scores instead of single events.

### SUMMARY OF THE INVENTION

Aspects of embodiments of the invention include Aspect 1: a method of monitoring computer activity comprising: performing distribution-based system state embedding on one or more attributes related to computer activity; training an anomaly detection machine learning model with the system state embedding; detecting one or more anomaly related to the computer activity; and reporting a threat relating to the one or more anomaly.

Aspect 2 is the method of Aspect 1, further comprising: categorizing audit log entries by one or more attributes, each comprising an action and an object, related to the computer activity; and identifying a window comprising selected audit log entries and selected attributes.

Aspect 3 is the method of Aspect 2, further comprising: calculating frequencies for the selected attributes; and normalizing the calculated frequencies, wherein the normalized calculated frequencies of the selected attributes form a first frequency vector.

Aspect 4 is the method of Aspect 2 or 3, further comprising: computing a score for each of the selected attributes using historical data.

Aspect 5 is the method of any of Aspects 2-4, further comprising: computing additional frequency vectors for multiple windows.

Aspect 6 is the method of any of Aspects 2-5, further comprising: determining distributions of calculated frequencies from the first frequency vector and/or one or more additional frequency vectors.

Aspect 7 is the method of any of Aspects 2-6, further comprising: obtaining a new frequency vector; calculating a probability score for the one or more attributes in the new frequency vector using a cumulative distribution function (CDF).

Aspect 8 is the method of any of Aspects 2-7, wherein the probability score is calculated as follows:

$$probability score = 1 - P ( μ - diff < X < μ + diff ) = 1 - ( {F}_{X} ( μ + diff ) - {F}_{X} ( μ - diff ) )$$

wherein:
X represents the distribution;
μ is the distribution mean;
diff is the difference between μ and a newly observed data point d;
F_{X} is the CDF of X, calculated as

$${F}_{X} ( x ) = P ( X \leq x ) = {\int }_{- ∞}^{x} {f}_{X} ( t ) dt ;$$

f_{X} is the probability density function (PDF) of X, calculated as

$${f}_{X} ( x ; μ , σ ) = \frac{1}{σ \sqrt{2 π}} {e}^{- \frac{1}{2} {( \frac{x - μ}{σ} )}^{2}} ;$$

and
σ is the standard deviation.

Aspect 9 is the method of any of Aspects 2-8, wherein the calculated probability scores form one or more system state score vectors.

Aspect 10 is the method of any of Aspects 1-9, wherein one or more system state score vectors are used to train the anomaly detection model.

Aspect 11 is the method of any of Aspects 1-10, wherein the one or more anomaly is identified using the anomaly detection model.

Aspect 12 is the method of any of Aspects 1-11, wherein the anomaly detection model comprises a self-reconstruction model trained by: reading one or more system state score vectors; encoding one or more system state score vectors; decoding the encoded one or more system state score vectors; and reconstructing the one or more system state score vectors.

Aspect 13 is the method of any of Aspects 1-12, wherein the anomaly detection model comprises a next-step reconstruction model trained to use a decoder to predict a system state for subsequent time windows using the one or more system state score vectors.

Aspect 14 is the method of any of Aspects 1-13, wherein the anomaly detection model comprises a composite model configured to use a first decoder to reconstruct the one or more system state score vectors and a second decoder to predict a system state for subsequent time windows using the one or more system state score vectors.

Aspect 15 is the method of any of Aspects 1-14, wherein the anomaly detection model is trained by encoding and learning system states from an infinite combination of behaviors.

Aspect 16 is the method of any of Aspects 1-15, further comprising interpreting predicted system states to detect anomalies.

Aspect 17 is the method of any of Aspects 1-16, further comprising minimizing the difference between one or more reconstructed vectors and one or more target vectors.

Aspect 18 is the method of any of Aspects 1-17, further comprising calculating mean absolute error between the one or more reconstructed vectors and one or more target vectors.

Aspect 19 is the method of any of Aspects 1-18, further comprising the mean absolute error for m time windows with n features as follows:

$${MAE}_{m} = {\sum }_{i = 1}^{m} \frac{1}{n} {\sum }_{j = 1}^{n} \vert {t}_{ij} - {r}_{ij} \vert$$

wherein tᵢⱼ represents the jth element in the ith time window for the one or more target vectors; and
wherein rᵢⱼ represents the jth element in the ith time window for the one or more reconstructed vectors.

Aspect 20 is the method of any of Aspects 1-19, wherein:
if the calculated mean absolute error exceeds a pre-determined threshold, then the window is flagged as abnormal; or
if the calculated mean absolute error does not exceed the pre-determined threshold, then the window is labeled as normal.

Aspect 21 is the method of any of Aspects 1-20, wherein the pre-determined threshold is selected to be two standard deviations from the distribution mean following the 68-95-99 rule.

Aspect 22 is the method of any of Aspects 1-21, wherein the method is capable of providing continuous monitoring.

Aspect 23 is the method of any of Aspects 1-22, wherein the method uses a neighbor-based continuous monitoring.

Aspect 24 is the method of any of Aspects 1-23, wherein for a target window wᵢ and a neighbor size b, the decision for the target window is determined as follows:

$${D}_{NCM} ( {w}_{i} ) = mode \{ D ( {w}_{i + k} ) \vert k ∈ [ - b , b ] , 0 ⩽ i + k ⩽ e \}$$

wherein e is the ending index of currently available predictions.

Aspect 25 is the method of any of Aspects 1-24, wherein the method is capable of detecting outlier events associated with one or more adversary tactics, such as Execution, Persistence, Privilege Escalation, Discovery, Lateral Movement, Collection, and Exfiltration.

Aspect 26 is a method of identifying a potential cyber threat, the method comprising: performing distribution-based system state embedding on one or more attributes related to a selected time window of computer activity; determining and comparing a system state score vector and a reconstructed system state score vector for one or more of the attributes to obtain an individual reconstruction error; comparing the individual reconstruction errors of the attributes to determine top abnormal attributes and identifying a category of each top abnormal attribute; determining one or more category-level error by performing a summation of the individual reconstruction errors within each category and identifying the category with the highest error; repeating the determining, comparing, identifying and summation steps for one or more additional or subsequent time window; determining a sequence of the highest error categories, thereby identifying dynamics of potential cyber threat behaviors; and comparing the sequence of the highest error categories against one or more known cyber threat pattern to identify potential cyber threats.

Aspect 27 is the method of any of Aspects 1-26, wherein the one or more attributes are selected from one or more of file, process, and/or registry categories.

Aspect 28 is a system capable of implementing the method of any of claims 1-27.

Aspect 29 is a system comprising:
a computer processor for executing computer-executable instructions;
a memory for storing the computer-executable instructions, wherein the computer-executable instructions are configured to:
detect one or more anomaly related to computer activity using a trained distribution-based statistical machine learning model; and
reporting a threat relating to the one or more anomaly.

Aspect 30 is the system of claim 29, wherein the distribution-based statistical model is trained using system state score vectors derived from a distribution-based system state embedding technique.

Aspect 31 is the system of claim 29 or 30, wherein the system is capable of detecting outlier events associated with one or more adversary tactics, such as Execution, Persistence, Privilege Escalation, Discovery, Lateral Movement, Collection, and Exfiltration.

### BRIEF DESCRIPTION OF THE DRAWINGS

The accompanying drawings illustrate certain aspects of implementations of the present disclosure and should not be construed as limiting. Together with the written description the drawings serve to explain certain principles of the disclosure.

FIG. 1 is an illustration showing an overview of a method for anomaly prediction and continuous monitoring according to an embodiment of the invention.

FIGS. 2A-B are graphs showing the behavior ratio of DARPA OpTC host 0501 during benign (FIG. 2A) and attack (FIG. 2B) periods.

FIG. 3 shows a simplified example of Madeline embedding (system state scores) computed from the DARPA OpTC dataset with five windows, each with twelve attribute scores, according to an embodiment of the invention.

FIG. 4 is an illustration showing the three LSTM reconstruction modes, according to an embodiment of the invention.

FIG. 5 shows an example of a neighbor-based continuous monitoring (NCM) feature to refine the prediction result, according to an embodiment of the invention.

FIGS. 6A-L are graphs showing the distribution of data reconstruction errors on attack scenarios from the DARPA OpTC dataset (SR—self-reconstruction; NR—next-step reconstruction; CO—composite).

FIGS. 7A-B are graphs showing the average memory usage (FIG. 7A) and peak memory usage (FIG. 7B) with Kairos on the DARPA OpTC dataset.

FIGS. 8A-H are plots showing the PCA analysis of benign and attack data of host 0051.

FIG. 9 is a graph showing the performance comparison with OC-SVM and autoencoder as baselines (linear—linear kernel; poly—polynomial kernel); 0.95 and 0.7 are values for nu parameter; Madeline's performance is based on the self-reconstruction setting.

FIG. 10 is an attack log for red team activities on host 0501 from the DARPA OpTC dataset and top abnormal categories for corresponding prediction windows predicted by Madeline.

FIGS. 11A-J are graphs showing the distribution of data reconstruction errors on attack-free hosts (self-reconstruction).

FIGS. 12A-F are graphs showing the prediction distribution for a variety of scenarios.

FIG. 13 is an illustration showing an overview of the investigation workflow, according to an embodiment of the invention.

FIG. 14 is a table showing how the top abnormal attributes and category are inferred by inspecting the individual reconstruction error of each attribute, according to an embodiment of the invention.

### DETAILED DESCRIPTION OF VARIOUS EMBODIMENTS OF THE INVENTION

The present invention, Madeline, enables lightweight real-time detection using an efficient approach that utilizes system states derived from historical statistics. As a graph-free framework, Madeline demonstrates remarkably reduced processing time for audit logs and encapsulates the system state in a highly condensed manner. The logs are first digested state scores using historical behavioral distribution. Without complex graph construction, statistics-based computation executes very fast. Then, the unsupervised machine learning model learns to reconstruct the benign states and detect the states that deviate from benign. Madeline further possesses a continuous monitoring feature, which helps comprehensively understand the risk over time and reduce false predictions.

One design requirement for using statistical methods for anomaly detection is to effectively capture the system states and reflect changes in behavior. System behaviors are inherently complex and noisy, with many tasks going on concurrently. With a vast amount of background activities, small changes may be buried under voluminous benign logs. It is critical to catch subtle yet abnormal patterns in system states.

A further design goal is reducing false alarms, which is critical for all threat detection systems. Existing works filter false alarms by considering the anomaliness of related events in the provenance graph (Dong, F. et al., 2023; Hassan, W. U. et al., Nodoze: Combatting threat alert fatigue with automated provenance triage. In Proceedings of Symposium on Network and Distributed System Security (NDSS), 2019). For distribution-based statistical models, when multiple tasks involve the same system behavior (e.g., file read), its frequency may vary and lead to an out-of-distribution score occasionally. Such unexpected fluctuations need to be properly handled.

Features of the present invention are summarized as follows:

Efficient detection framework. Madeline is a lightweight detection designed to respond to advanced threats promptly. Research has shown that a fast response to such attacks can significantly reduce financial loss and help prevent future damage (Liu, Y. et al. Towards a Timely Causality Analysis for Enterprise Security. In Proceedings of Symposium on Network and Distributed System Security (NDSS), 2018). Madeline has been extensively evaluated using three APT attack scenarios and ten attack-free scenarios from the DARPA OpTC dataset. Madeline effectively detects all attack periods with an average recall of 0.988 and a FPR of 0.03. Madeline-NCM further improves the recall to 0.996 and reduces the FPR to 0.011. When comparing Madeline with state-of-the-art APT detections, Madeline shows comparable accuracy and is significantly more lightweight than graph-based solutions, achieving over 1000× reduction in processing time and up to 5.2× reduction in memory usage. This efficiency improvement is due to the elimination of entity- and event-level computations, which demand excessive computational time and resources.

Compact distribution-based state embedding. To accurately represent the system state, a multi-step method leveraging historical system behavior distribution is used. It converts complex system states to highly compact score vectors with minimal computational overhead. To prevent log accumulation during peak hours, sliding windows containing a fixed number of logs are selected. In this way, busy hours with increased activities will be expanded into more windows, enhancing the likelihood of detecting subtle changes. The occurrence frequencies are further normalized by the window size to reflect the ratio of behaviors, depicting the relationship between different behaviors.

Multi-attribute system representation. To mitigate the risk of false positives from fluctuations in a single behavior, a collection of behavioral attributes are considered and a set of scores to represent the overall system state are calculated. The anomaly detection model receives the vector of scores as an ensemble, learns the pattern across behaviors, and thereby makes more informed predictions.

Neighbor-based continuous monitoring. To enhance the assessment of ongoing risk, Madeline incorporates continuous monitoring that evaluates the risk levels across successive time windows. Consecutive high-risk predictions are more indicative of a truly high-risk period, whereas isolated anomaly predictions may reflect unexpected fluctuations in behavior. Neighbor-based continuous monitoring (NCM) is introduced to reduce false alarms by 63%, saving time and resources spent on investigating each alert. As a result, security analysts can concentrate on periods of genuine high risk.

### Overview

Madeline aims to detect any abnormal behaviors that leave a record in the system audit log. It is assumed that 1) the audit logs are not tempered or erased by any malicious actors to hide their traces, and 2) the benign period used for model training is attack-free.

The detection mechanism of Madeline is demonstrated using a simplified attack example from the DARPA OpTC dataset (FiveDirections/OpTC-data. https://github.com/FiveDirections/OpTC-data).

For the attack scenario, an enterprise has several endpoint machines running various routine tasks. One day, an attacker sends spear phishing emails containing malicious attachments named payroll.docx. A victim employee downloads and opens the file, and the attacker checks in. The attacker first makes several attempts to modify the registry and sets persistence in the host to check back consistently. Then, they enumerate the files and search for “important, secret, classified” keywords to collect host information. Finally, they compress files in C:// documents for exfiltration.

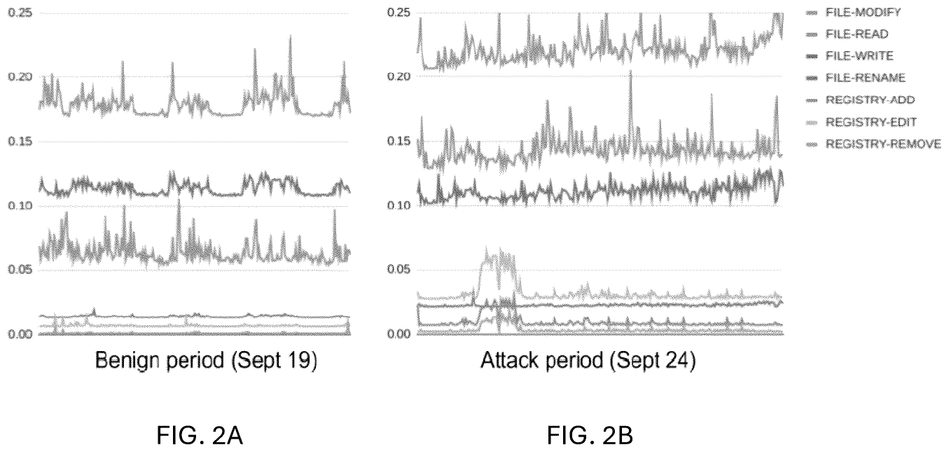

Madeline identifies system changes using behavioral statistics. At the beginning of the attack, as the attacker attempts to establish persistence, the proportion of registry related activities tends to increase abnormally. Subsequently, during file exfiltration, compression will also exhibit distinct file operation patterns. For instance, file read increases during information gathering and file compression (FIG. 2). Variations in these operations will affect the ratio of other behaviors to varying degrees, collectively indicating a change in the system. When these abnormal states are compared to the historical system state distribution, they will receive an out-of-distribution score, which the anomaly detection model can flag later. Investigative resources can be conserved by prioritizing the analysis of these high-risk periods. Since Madeline only relies on counting behavior frequencies and calculating state scores using statistical models, the computational overhead is minimal. This allows detection to occur within seconds even for large volumes of system logs, thus enabling real-time threat detection. Moreover, storing historical system behaviors as state scores consumes minimal space, requiring only a few megabytes for days of events. Madeline can also complement existing fine-grained analysis approaches.

Existing graph-based solutions (Cheng, Z. et al., KAIROS: Practical Intrusion Detection and Investigation using Whole-system Provenance. In 2024 IEEE Symposium on Security and Privacy (SP). 5-5; Han, X. et al., UNICORN: Runtime Provenance-Based Detector for Advanced Persistent Threats. In Proceedings of Symposium on Network and Distributed System Security (NDSS), 2024; Milajerdi, S. et al., HOLMES: Real-Time APT Detection through Correlation of Suspicious Information Flows. In 2019 IEEE Symposium on Security and Privacy (SP). 1137-1152; Zeng, J. et al., Shadewatcher: Recommendation-guided cyber threat analysis using system audit records. In 2022 IEEE Symposium on Security and Privacy (SP). IEEE, 489-506) require significant analysis time and computational resources, making prompt detection and response challenging. This is because event-level detection requires investigating every single event and its dependencies. To expedite the analysis, some approaches utilize multi-threading (Cheng, 2024; Zeng, 2022), which may consume substantial computational power and potentially slow down other tasks. In this attack example, suspicious events include abnormal process creation from a malicious file, unusual reads of files by unknown processes, and suspicious file creations by unknown processes. To pinpoint these events or the trace containing them, each event needs to be indexed and linked, while massive iterations are needed to trace event context. This results in substantial storage, memory, and computational overheads. Additionally, historical graphs often cannot be deleted because future anomaly scores may depend on them. The significant time and memory utilization reduction of Madeline is experimentally confirmed as discussed herein.

### Overview of Madeline

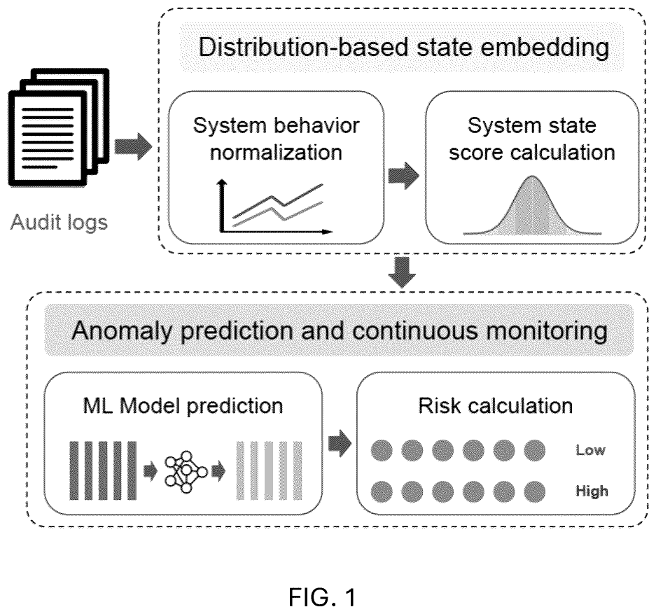

Madeline, an unsupervised learning-based threat detection leveraging system state computed based on historical statistics, consists of two major steps: 1) distribution-based system state embedding, and 2) anomaly detection and risk evaluation (FIG. 1).

To capture system state information in a condensed way, the audit logs are first converted to vectors with statistics of various behaviors. Each vector represents a short time window. When historical data accumulates, a distribution can be deduced and where a newly observed state falls in this distribution can be inferred. Each behavior attribute has its own score, and together they represent the state of the current system. Then, an LSTM-autoencoder learns to reconstruct the state score for a few consecutive time windows. The model is trained on only benign data. As a result, states close to observed normal data will have a lower reconstruction error, whereas states that deviate from normal will have a higher error.

The key idea behind the design is to let the model learn the relationship between each attribute in a time window and how this relationship changes over time across multiple time windows. Even though system behaviors could be complex and noisy, system states should reasonably repeat themselves during regular routines. Changes in one or more behavior attributes will make the calculated state deviate from the benign distribution. Log entries (i.e., activities) often do not follow a strict temporal order due to concurrent tasks and multithreading. The present design considers the activities accumulated during a time window, also helping reduce the impact of this variance.

### Design of Madeline

Distribution-based system state embedding converts complex system states into score vectors. Benign behavior learning and anomaly prediction involves training the model using historical normal behaviors and identifying abnormal states based on the model's output. Continuous monitoring facilitates an enhanced assessment of ongoing risk.

### Distribution-Based System State Embedding

The goal of this phase is to convert the system state to a compact vector representation (embedding).

Behavior attribution. First, Madeline takes the audit log as input and categorizes the log entries by the action and related object. One type of event, which is a combination of object and action, is considered as one attribute (e.g., PROCESS OPEN, FILE CREATE).

Behavior normalization. For a fixed-size window (e.g., 10,000 log entries), each attribute's frequency is counted and the frequencies are normalized by the total number of actions. That is, as shown in Equation 1, for each selected attribute i,

$${freq}_{i} = \frac{\# occurrences of {attribute}_{i}}{length of window} \qquad ( 1 )$$

The calculated frequencies of all attributes form a vector, representing the activities happening in this time window. The fixed-sized window design helps catch subtle changes during peak hours.

State score calculation. A score is then computed for each attribute utilizing historical data. After computing the frequency vectors for a few time windows, distributions of each attribute's frequency can be formed from past data. When given a new behavior frequency vector, the probability of each value happening can be deduced from its historical distribution. Then, the cumulative distribution function (CDF) can be used to calculate this probability for each attribute in the vector.

$$score = 1 - P ( μ - diff < X < μ + diff ) = 1 - ( {F}_{X} ( μ + diff ) - {F}_{X} ( μ - diff ) ) \qquad ( 2 )$$

where X represents the distribution, μ is the distribution mean, diff is the difference between μ and the newly observed data point d:

$$diff = \vert μ - d \vert \qquad ( 3 )$$

F_{X} is the CDF of X:

$${F}_{X} ( x ) = P ( X \leq x ) = {\int }_{- ∞}^{x} {f}_{X} ( t ) dt \qquad ( 4 )$$

and f_{X} is the probability density function (PDF) of X:

$${f}_{X} ( x ; μ , σ ) = \frac{1}{σ \sqrt{2 π}} {e}^{- \frac{1}{2} {( \frac{x - μ}{σ} )}^{2}} \qquad ( 5 )$$

with σ being the standard deviation (std).

Calculating these scores for the attributes generates a new vector representing the system state. Beyond the attribute relationship represented in the frequency vector, the state scores further encode information from the past, capturing the changing pattern of system behaviors. The score vectors are then used in the next step as the input for learning the anomaly detection model. The state score vectors are referred to as Madeline embedding. Compared to existing embedding methods, such as word2vec (Mikolov, T. et al., Efficient Estimation of Word Representations in Vector Space, 2013, arXiv:1301.3781 [cs.CL]) and log 2vec (Liu, F. et al., Log 2vec: A heterogeneous graph embedding based approach for detecting cyber threats within enterprise. In Proceedings of the 2019 ACM SIGSAC conference on computer and communications security. 1777-1794), Madeline relies solely on statistical models and does not require training, thus enabling rapid computation.

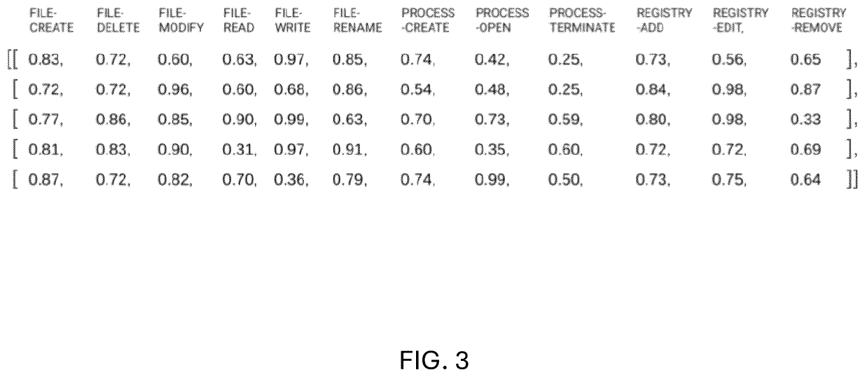

FIG. 3 shows a simplified example of Madeline embedding (system state scores) computed from the DARPA OpTC dataset. The example shows 5 windows, each with 12 attribute scores.

### Benign Behavior Learning and Anomaly Prediction

This phase contains two steps. One is benign behavior learning, which aims to learn a model that accurately reconstructs the historical system state. The other is anomaly prediction, with a goal to identify abnormal system states from model predictions.

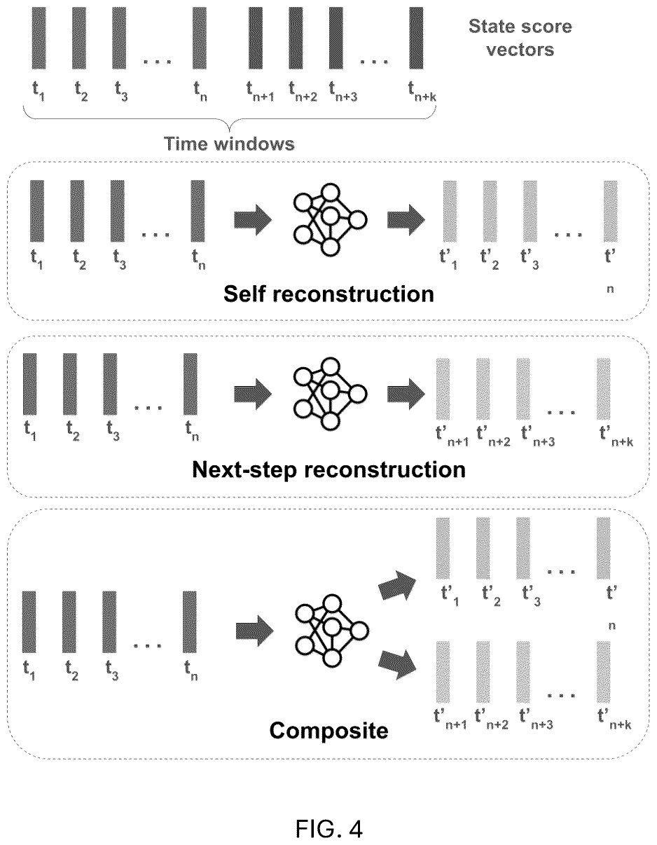

Benign behavior learning. An LSTM autoencoder was chosen as the anomaly detection model. LSTM is known for its capability of handling sequential time series and the autoencoder enables learning without attack labels. This unsupervised design helps address the challenge of the limited availability of attack data for training in a realistic setting. Compared to advanced Transformer-based models, LSTM has fewer parameters and requires less time for training. The model is implemented using an encoder-decoder LSTM architecture. The model is trained with the previously computed state scores to learn the normal system state by a reconstruction task. The input is a few consecutive state score vectors and the learning goal is to minimize the difference between the recreated vectors and target vectors. The difference is measured by mean square error (MSE), which is used as the loss function. Specifically, three reconstruction modes are provided (FIG. 4):

Self-reconstruction. In this mode, the model learns to reconstruct the input. The model reads the state score vectors, encodes them, decodes them, and tries to reconstruct them. That is, the model only handles the current system state.

Next-step reconstruction. In this mode, the decoder is modified to create the state vectors following the input. The model parses the current system state and is asked to predict the state for subsequent time windows.

Composite setting. In this mode, self-reconstruction and next-step reconstruction are combined with two decoders. One decoder is responsible for reconstructing the input and the other for recreating the next steps. Model's output includes both the reconstructed current state and the subsequent state.

Unlike existing LSTM-based anomaly detection methods, such as DeepLog (Du, M. et al., DeepLog: Anomaly detection and diagnosis from system logs through deep learning. In Proceedings of the 2017 ACM SIGSAC conference on computer and communications security. 1285-1298), which can only handle a finite set of events, Madeline can flexibly encode and learn system states from infinite combinations of behaviors.

Anomaly prediction. Next, the prediction is interpreted to detect anomalies in system state. Each sliding window receives a separate security decision. The reconstruction error is calculated to quantify the deviation from normal. The reconstruction error is calculated as the mean absolute error (MAE) between the target vectors and the reconstructed vectors element-wise. The MAE for m time windows with n features are shown in Equation 6.

$$M A {E}_{m} = {\sum }_{i = 1}^{m} \frac{1}{n} {\sum }_{j = 1}^{n} \vert {t}_{ij} - {r}_{ij} \vert \qquad ( 6 )$$

Here, t and r represent the target and reconstruction vectors, respectively. tᵢⱼ and rᵢⱼ represent the jth element in the ith time window in t and r, respectively.

If the reconstruction error exceeds a pre-determined threshold, then the window is flagged as abnormal (positive); otherwise, it will be labeled as normal (negative).

$$prediction = \{ \begin{matrix}positive ( abnormal ) , & if M A E > th \\ negative ( normal ) , & otherwise\end{matrix} \qquad ( 7 )$$

A decision threshold is selected that is two standard deviations from the distribution mean following the 68-95-99 rule (Equation 8), that is, theoretically, 95% of data from the same distribution should fall within this range.

$$th = μ + 2 σ \qquad ( 8 )$$

Here, μ is the distribution mean and σ is the standard deviation. The threshold th is determined on the validation set.

### Continuous Monitoring and Madeline-NCM

Continuous monitoring is critical for defending against APTs because of their low-and-slow characteristics. The goal is to support a more comprehensive understanding of ongoing risk by providing context to a specific decision. False alarms or missed detections are unavoidable due to the complex nature of system behaviors. For instance, when various tasks run simultaneously during heavy usage time, an unexpected ratio of behavioral attributes may appear in a sliding window and consequently lead to an alarm. This false prediction could be reduced by inspecting the risk level of adjacent periods. If the risk level is continuously low, investigative efforts can be prioritized to other higher-ranked alarms.

Adapting this idea, a neighbor-based continuous monitoring (NCM) feature is introduced. This feature helps reduce false positives and missed detection by considering the predictions on consecutive windows and taking the majority vote. Given target window wᵢ and a neighbor size b, the decision for wᵢ becomes

$${D}_{NCM} ( {w}_{i} ) = mode \{ D ( {w}_{i + k} ) \vert k ∈ [ - b , b ] , 0 ⩽ i + k ⩽ e \} \qquad ( 9 )$$

where D is the decision of a window wand e is the ending index of currently available predictions.

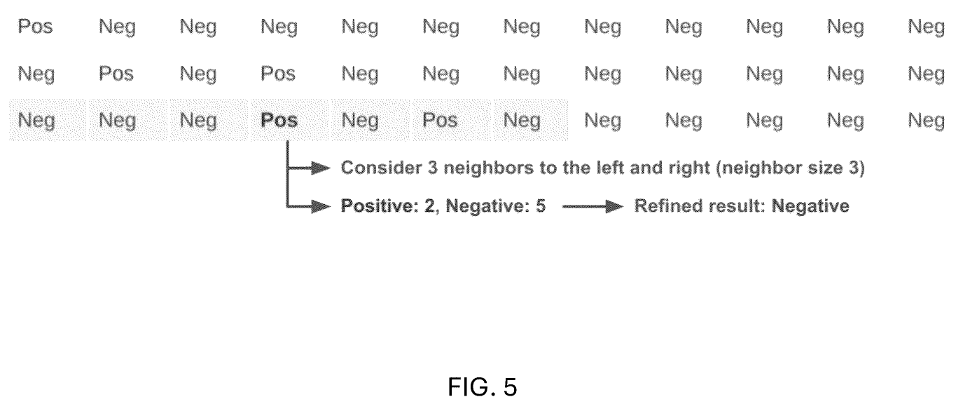

The model incorporating this feature is referred to as Madeline-NCM. FIG. 5 shows a simple example, in which the prediction result of a particular time window (false positive) is replaced with the predominant vote among its neighbors.

Extensive experiments were conducted to evaluate the efficacy and efficiency of Madeline as a detection system. In particular, the following questions were investigated:
RQ1. How effective is Madeline in detecting advanced threats in different attack scenarios?
RQ2. How does Madeline compare with the state-of-the-art threat detection methods in terms of accuracy, training and prediction time, and computational resource utilization?
RQ3. How do different design choices impact the detection efficacy of Madeline?
RQ4. How would continuous monitoring help reduce false alarms?

The efficacy of Madeline is first evaluated on three different APT attack scenarios and ten attack-free scenarios from a large-scale DARPA dataset. Madeline effectively detects the attack periods with very few positives. Madeline is then compared with three state-of-the-art APT detection approaches. The results show that Madeline achieves comparable accuracy with the state-of-the-art solutions. The computation time and resources needed were further compared with graph-based solution KAIROS (Cheng, 2024), demonstrating the advantage in lightweight online detection. A comprehensive ablation study was conducted and the impact of various design choices on the performance of Madeline is discussed.

Experimental setup. All experiments are performed on a machine with Intel Core i7 11700K CPUs @3.6 GHz, 64 GB memory, and an NVIDIA GeForce RTX 3090 GPU. Ubuntu 22.04 LTS was used as the operating system. Unless otherwise specified, an LSTM model with an encoder-decoder structure was used, optimized by Adam optimizer. The encoder contains 2 layers with 64 and 128 units, respectively. The decoder contains 2 layers, with 128 and 64 units, respectively. The models were implemented in Python using TensorFlow. The statistical models and scores are computed using Scipy. A sliding window size of 10,000 and a stride of 1000 were used.

For the LSTM self-reconstruction setting, an input and output size of 5 (i.e., 5 sequential score vectors) was used. For the next-step reconstruction setting, an input size of 5 and an output size of 3 was used. For the composite setting, an input size of 5, and output sizes of 5 (self-reconstruction) and 3 (next-step reconstruction) were used for the two decoders. Recall and false positive rate (FPR) were used as evaluation metrics.

TABLE 1
Attributes selected for DARPA OpTC dataset.

| Category | Attributes |
|---|---|
| FILE | FILE-CREATE, FILE-DELETE, FILE-MODIFY, |
| | FILE-READ, FILE-WRITE, FILE-RENAME |
| PROCESS | PROCESS-CREATE, PROCESS-OPEN, |
| | PROCESS-TERMINATE |
| REGISTRY | REGISTRY-ADD, REGISTRY-EDIT, REGISTRY- |
| | REMOVE |

Datasets. Two datasets were used in the evaluation.

DARPA OpTC. The DARPA Operationally Transparent Cyber

OpTC is a large-scale APT dataset containing log records for both benign and red-team simulated malicious activities. This dataset was collected in 2019 from around 1000 Windows 10 hosts. It describes both a benign period (September 17-23) and an attack period (September 23-25). During the attack period, the red team injected malicious behaviors with benign background activities running. A summary of the attack scenarios is shown in Table 11. The data is publicly available in eCAR format as JSON files (DARPA OpTC ecar—Google Drive. https://drive.google.com/drive/u/0/folders/1NwaCWRyr_coyPbF2SvScbani5O9MXp7_).

TABLE 11
Attack scenarios of DARPA OpTC dataset.

| Attack scenario | Date | Attacked hosts |
|---|---|---|
| Plain PowerShell Empire | Sept 23 (day 1) | 0201, 0660 |
| Custom Powershell Empire | Sept 24 (day 2) | 0501 |
| Malicious Upgrade | Sept 25 (day 3) | 0051 |

StreamSpot. The StreamSpot dataset consists of data derived from 1 attack and 5 benign scenarios. The benign scenarios depict normal activities, such as browsing YouTube and playing video games. The attack involves a drive-by download triggered by visiting a malicious URL. For each scenario, 100 tasks were automatically executed on a Linux machine.

### RQ1: Recall and FPR of Madeline

Madeline was evaluated on both attack scenarios and benign scenarios from the DARPA OpTC dataset. The results suggest that Madeline can effectively detect malicious periods. Four attacked hosts were used from all three attack scenarios and ten randomly selected benign (i.e., attack-free hosts) to test the number of false alarms generated by Madeline. For attacked hosts, the last benign period was saved as validation and testing sets and the rest was used as the training set. The data was labeled during the corresponding attack times in their evaluation directory as attack logs for evaluation. One thing worth noting is that the entire attack period was labeled as positive instead of labeling individual events (i.e., single log entries) because of the nature of the lightweight coarse-grained online detection. For attack-free hosts, a similar training and validation setting are used, with data from the day 1 attack period as testing. Because these hosts are not the target of the red team, there should be only benign background activities running even during the attack time. Those data were used to extensively test the amount of false alarms generated by Madeline.

For the DARPA OpTC dataset, twelve attributes were selected from three different categories, namely file, process, and registry (Table 1). Those categories were selected as they cover a wide range of adversary enterprise tactics, including Execution, Persistence, Privilege Escalation, Discovery, Lateral Movement, Collection, and Exfiltration (Tactics—Enterprise MITRE ATT&CK. https://attack.mitre.org/tactics/enterprise/). Each attribute is a combination of an object and an action. The frequency of each attribute was calculated and subsequently the state scores. A simplified input embedding example of input size 5 is shown in FIG. 3.

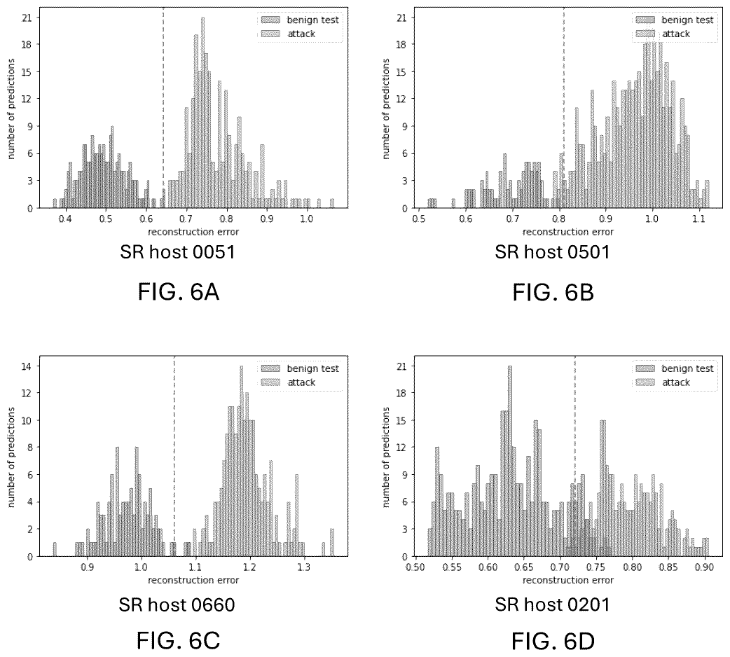

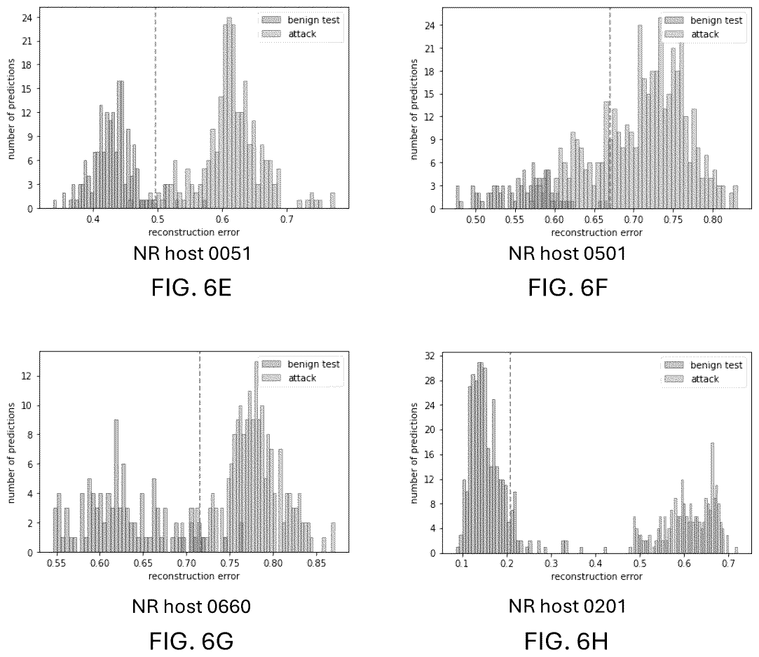

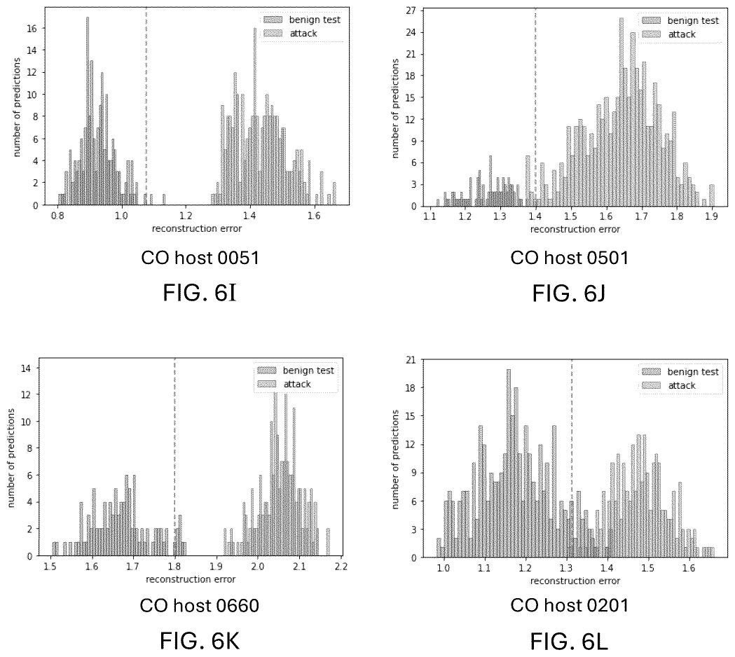

Evaluation on APT attack scenarios. Tables 2 and 3 show a summary of the results on 4 attack hosts. The distributions of reconstruction errors are shown in FIGS. 6A-L. In all cases, benign and attack data showed a good separation, achieving good recall and low FPR. Specifically, self-reconstruction and composite settings achieve an average recall of over 0.98 and an average FPR as low as 0.03. The composite setting shows slightly better separation between benign and attack compared to the reconstruction setting. Next-step reconstruction has a slightly lower recall at 0.93. One possible reason for the small number of missed detections is that, due to the complex nature of system behaviors, the scores of a few windows may fall in the normal range. Similarly for false alarms. Missed detections and false alarms can be remarkably reduced with the continuous monitoring feature (Tables 2 and 3).

The self-construction setting approaches the performance of composite setting but requires less training time, making it a practical choice for most scenarios. However, when optimal accuracy is important, the composite setting becomes a preferable option.

TABLE 2
Recall of Madeline on attack scenarios from DARPA OpTC dataset
with and without the neighbor-based continuous monitoring (NCM)
feature (neighbor size 5). NCM improves recall in all cases.

| | Self- | | Next-step | | | |
|---|---|---|---|---|---|---|
| | reconstruction | | reconstruction | | Composite | |
| Host | — | w/ NCM | — | w/ NCM | — | w/ NCM |
| 0051 | 1.000 | 1.000 | 0.980 | 0.996 | 1.000 | 1.000 |
| 0501 | 0.971 | 0.985 | 0.759 | 0.768 | 0.980 | 1.000 |
| 0660 | 1.000 | 1.000 | 0.963 | 1.000 | 1.000 | 1.000 |
| 0201 | 0.979 | 1.000 | 1.000 | 1.000 | 0.991 | 1.000 |
| avg | 0.988 | 0.996 | 0.926 | 0.941 | 0.993 | 1.000 |

TABLE 3
FPR of Madeline on attack scenarios from DARPA OpTC dataset
with and without the neighbor-based continuous monitoring (NCM)
feature (neighbor size 5). NCM reduces FPR in all cases.

| | Self | | Next-step | | | |
|---|---|---|---|---|---|---|
| | reconstruction | | reconstruction | | Composite | |
| Host | — | w/ NCM | — | w/ NCM | — | w/ NCM |
| 0051 | 0.005 | 0.000 | 0.029 | 0.000 | 0.011 | 0.000 |
| 0501 | 0.000 | 0.000 | 0.000 | 0.000 | 0.000 | 0.000 |
| 0660 | 0.019 | 0.000 | 0.039 | 0.000 | 0.049 | 0.000 |
| 0201 | 0.095 | 0.043 | 0.096 | 0.049 | 0.087 | 0.046 |
| avg | 0.030 | 0.011 | 0.041 | 0.012 | 0.037 | 0.012 |

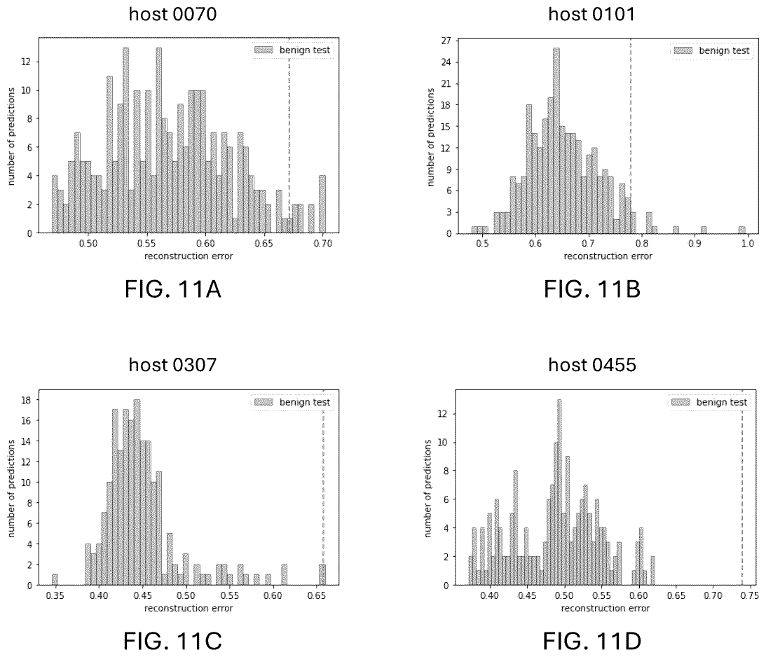

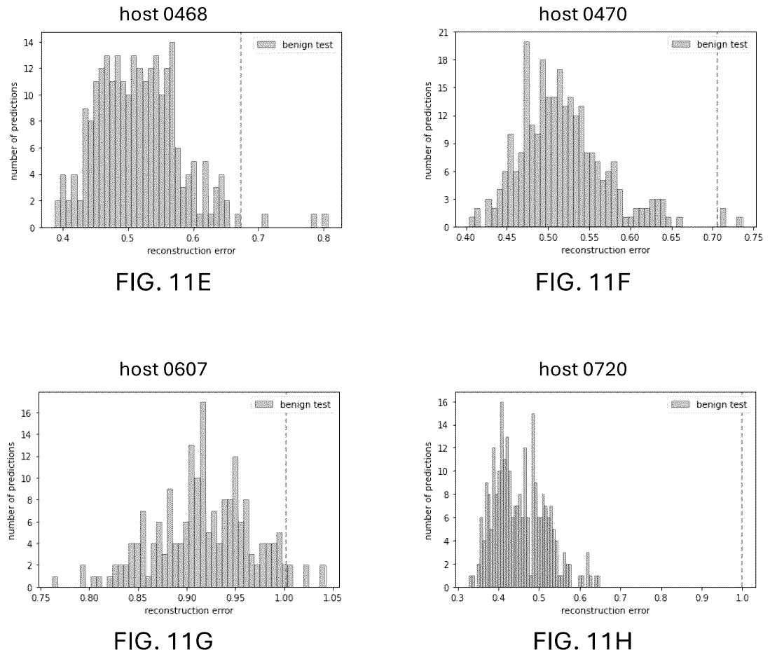

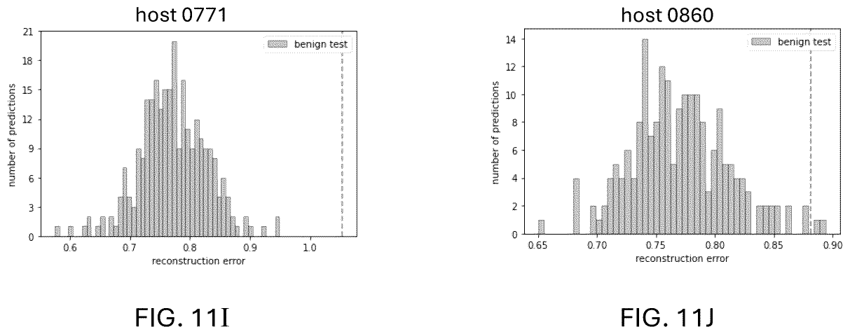

Evaluation on benign scenarios. Ten attack free hosts were randomly selected from the DARPA OpTC dataset to further test the number of false alarms Madeline generates. The findings indicate that, in addition to effectively detecting abnormal behaviors within the system, Madeline also successfully maintains a minimal rate of false alarms (Table 4A and FIG. 11).

RQ2: Comparison with State-of-the-Art Detections

Madeline was compared with state-of-the-art advanced threat detections, evaluating detection accuracy, processing time, and computational resource utilization. It was observed that Madeline achieves comparable accuracy and is substantially more lightweight and faster than graph-based solutions.

TABLE 4A
FPR of Madeline on attack-free scenarios from DARPA
OpTC dataset. SR for self-reconstruction, NR for
next-step reconstruction, CO for composite.

| Host | SR | NR | CO |
|---|---|---|---|
| 0070 | 0.042 | 0.000 | 0.000 |
| 0101 | 0.028 | 0.051 | 0.044 |
| 0307 | 0.022 | 0.000 | 0.011 |
| 0455 | 0.000 | 0.028 | 0.000 |
| 0468 | 0.012 | 0.012 | 0.012 |
| 0470 | 0.011 | 0.004 | 0.019 |
| 0607 | 0.031 | 0.021 | 0.016 |
| 0720 | 0.000 | 0.000 | 0.000 |
| 0771 | 0.000 | 0.008 | 0.000 |
| 0860 | 0.040 | 0.005 | 0.082 |
| avg | 0.019 | 0.013 | 0.018 |

Comparison of detection accuracy. Madeline was evaluated on the StreamSpot dataset and compared to state-of-the-art anomaly detection systems, including StreamSpot (Manzoor, E. et al., 2016. Fast Memory efficient Anomaly Detection in Streaming Heterogeneous Graphs. In Proceedings of the 22nd ACM SIGKDD International Conference on Knowledge Discovery and Data Mining, 1035-1044), Unicorn (Han, 2020), and Kairos (Cheng, 2024). The StreamSpot dataset (Manzoor, 2016) was chosen for comparison because it provides an isolated attack scenario, ensuring compatibility of the attack label across various detection tools. While large APT datasets, such as DARPA OpTC, depict more advanced threats, the attack labeling process may vary from work to work depending on their attack analysis strategies and granularity. Therefore, although StreamSpot contains a relatively simple attack, it facilitates a more straightforward and fair comparison.

Separate models were trained using each benign scenario and a combined model using all five benign scenarios. In each setting, 80% of the data was used as the training set, 10% as the validation set for threshold selection, and 10% as the benign testing set to assess the FPR. Then, each trained model was evaluated against the attack scenario to determine recall.

Attributes were chosen from the file and process categories. The StreamSpot dataset does not have any registry-related objects as it was run on a Linux machine. The 26 selected attributes are shown in Table 4B.

TABLE 4B
Attributes selected for StreamSpot dataset.

| Category | Attributes |
|---|---|
| file | file-execve, file-access, file-open, file-fstat, file- |
| | mmap2, file-close, file-read, file-stat, file-write, |
| | file-unlink, file-listen, file-chmod, file-connect, |
| | file-writev, file-recv, file-ftruncate, file-sendmsg, |
| | file-send, file-recvmsg, file-accept, file-sendto, |
| | file-recvfrom, file-truncate, file-bind |
| process | process-clone, process-waitpid |

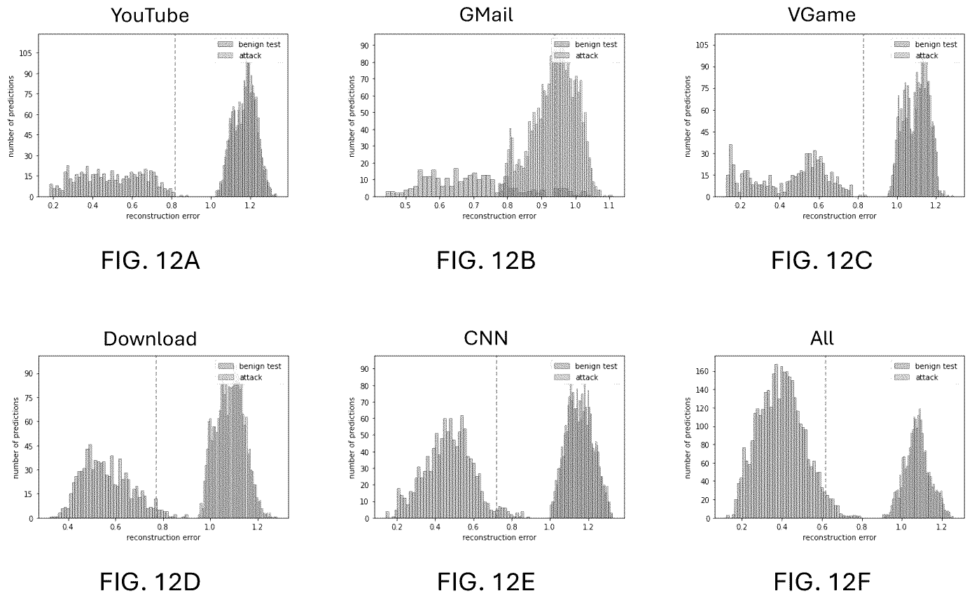

A summary of Madeline's performance is shown in Table 5. Madeline performs consistently well on all scenarios except for the GMail scenario. The GMail scenario has a notably small data size, which is only 36% of the Download scenario and 27% of the CNN scenario. This small data size may be inadequate for the deep learning model to effectively learn, leading to relatively high reconstruction errors for some benign time windows and subsequently a higher decision threshold. The prediction distribution is shown in FIG. 12.

TABLE 5
Performance of Madeline on StreamSpot dataset.

| | Self | | Next-step | | | |
|---|---|---|---|---|---|---|
| | reconstruction | | reconstruction | | Composite | |
| Scenario | Recall | FPR | Recall | FPR | Recall | FPR |
| You Tube | 1.000 | 0.003 | 0.984 | 0.025 | 1.000 | 0.000 |
| GMail | 0.537 | 0.081 | 0.615 | 0.061 | 0.947 | 0.037 |
| VGame | 1.000 | 0.002 | 0.964 | 0.010 | 1.000 | 0.000 |
| Download | 1.000 | 0.032 | 0.947 | 0.039 | 1.000 | 0.037 |
| CNN | 1.000 | 0.032 | 1.000 | 0.031 | 1.000 | 0.022 |
| All | 1.000 | 0.033 | 0.976 | 0.028 | 1.000 | 0.021 |
| avg | 0.923 | 0.031 | 0.914 | 0.032 | 0.991 | 0.020 |

The state-of-the-arts on the combined scenario (i.e., using combined data from the 5 benign scenarios for training) were compared next. The results are presented in Table 6. Madeline shows comparable detection accuracy. Madeline is notably more lightweight in terms of processing time and computational resource usage.

Table 6 below provides a comparison of detection accuracy with state-of-the-art on StreamSpot dataset. The performance of StreamSpot (Manzoor, 2016) and Unicorn (Han, 2020) are reported in the original Unicorn paper. The performance of Kairos is reported in the original Kairos paper (Cheng, 2024). The performance of FLASH is reported in the original FLASH paper (Rehman, M. U. et al., FLASH: A Comprehensive Approach to Intrusion Detection via Provenance Graph Representation Learning. In 2024 IEEE Symposium on Security and Privacy (SP). IEEE Computer Society, 139-139). The Performance of THREATRACE is reported in the original THRATRACE paper (Wang, S. et al., 2022. Performance of Madeline is based on the self-reconstruction setting. NCM refined performance uses a neighbor size of 5.

TABLE 6
Comparison of detection accuracy with
state-of-the-art on StreamSpot dataset.

| | Recall | FPR | Accuracy |
|---|---|---|---|
| Stream Spot | N/A | N/A | 0.660 |
| UNICORN | 0.930 | 0.020 | 0.940 |
| KAIROS | 1.000 | 0.000 | 1.000 |
| FLASH | 0.960 | 0.000 | 0.960 |
| THREATRACE | 0.990 | 0.004 | 0.990 |
| Madeline (ours) | 1.000 | 0.033 | 0.979 |
| Madeline-NCM (ours) | 1.000 | 0.004 | 0.997 |

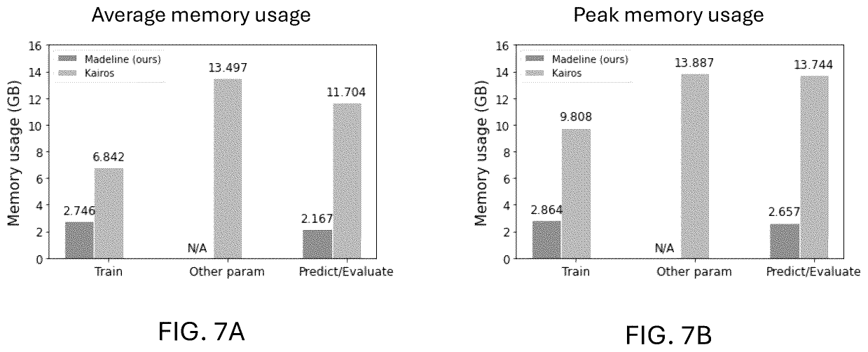

Comparison of processing time and resource utilization. Madeline's processing time and memory utilization were compared with state-of-the-art detection Kairos (Cheng, 2024) on the DARPA OpTC dataset. Because Kairos uses a multi-host training setting, Madeline's training and evaluation time for all 4 hosts together was compared for a fair comparison. The implementation of Kairos is available on GitHub (ProvenanceAnalytics/kairos—GitHub. https://github.com/ProvenanceAnalytics/kairos/blob/main/DARPA/OpTC/optc_graph_learning. Ipynb). Besides training and prediction, Kairos has an extra step of calculating each node's inverse document frequency (node_IDF) for anomalous score evaluation. This part is reported as other parameter calculation (labeled as other param in Table 7 and FIGS. 7A-B). Both sets of experiments are conducted on the same machine as described previously.

Due to the ability of Madeline to efficiently condense the system state into a few score vectors, both the training and prediction phases are executed very fast. A breakdown of the processing time needed for each stage is shown in Table 7, and memory utilization is shown in FIGS. 7A-B. Madeline achieves an increase of over 1000× in detection processing time in total and up to 5.2× reduction in memory utilization. This efficiency improvement is because of the fact that fine-grained detection at the node and edge level requires extensive computational effort. Specifically, in the case of Kairos, each node must be checked against every event in all preceding time windows to assess the node's rarity and, subsequently, to determine the benignness of future events involving this node. While providing fine-grained information for attack flow reconstruction, the substantial amount of processing time significantly increases the difficulty of deploying graph-based detection as a real-time solution. Although Madeline presents coarse-level prediction over time intervals, its fast reaction allows early intervention in response to attack behaviors. It is important to note that Madeline can also serve as a complement to existing fine-grained analyses, helping prioritize the investigation on high-risk time intervals, thereby conserving time and reducing manual efforts. A detailed use scenario is further discussed below.

TABLE 7
Comparison of processing time with
Kairos on DARPA OpTC dataset.

| | | Other | Predict/ | |
|---|---|---|---|---|
| | Train | param | Evaluate | Total |
| Madeline (ours) | 48 s | N/A | 4 s | 52 s |
| Kairos | 229 m 50.2 s | 797 m 18 s | 65 m 12 s | 1092 m 20 s |

### RQ3: Ablation Study

The influence of various design choices was analyzed using the self-construction setting on attack scenarios from the DARPA OpTC dataset. One design choice was adjusted at a time to examine its impact on Madeline's performance.

Decision threshold. The default decision threshold was selected as 2 stds from the mean (Equation 8) following the 68-95-99 rule of normal distribution. Next, the impact of selecting different thresholds was examined. Table 8 shows the experimental results. Shifting the threshold to the left enhances sensitivity to abnormal data, thereby increasing both the recall and the FPR. Using 1 standard deviation from the mean as the threshold, the FPR increases by 5 times. On the other hand, shifting the threshold to the right lowers the sensitivity, reducing the value of both metrics. Using 3 standard deviation from the mean as the threshold, the average recall drops to 0.85. Those numbers show that 2 standard deviations (stds) from the mean achieve a good balance.

TABLE 8
Comparison of decision thresholds on reconstruction error

| | | | mean + 2 * std | | | |
|---|---|---|---|---|---|---|
| | mean + 1 * std | | (default) | | mean + 3 * std | |
| Host | Recall | FPR | Recall | FPR | Recall | FPR |
| 0051 | 1.000 | 0.068 | 1.000 | 0.005 | 0.904 | 0.000 |
| 0501 | 1.000 | 0.148 | 0.971 | 0.000 | 0.862 | 0.000 |
| 0660 | 1.000 | 0.154 | 1.000 | 0.019 | 0.985 | 0.000 |
| 0201 | 1.000 | 0.243 | 0.979 | 0.095 | 0.654 | 0.000 |
| avg | 1.000 | 0.153 | 0.988 | 0.030 | 0.851 | 0.000 |

Input size. Input size refers to the number of steps (i.e., continuous time windows) fed into the LSTM autoencoder models. FIG. 3 shows an example of input size 5. Increasing this size provides more context for the models to learn, at a cost of slightly elevated training time. A comparison of 3 different input sizes is shown in Table 9. An input size of 5 achieves good performance while further increasing the size trivially improves it.

Sliding size. This value determines the number of logs included in one single sliding window. A small sliding size records a shorter period and provides us with more data points at the time of investigation. However, a size that is too small allows limited context in one window, possibly making the scores fluctuate a lot and thus hard for the model to learn. A balance needs to be established between these two aspects. Five sliding sizes were compared on two attack scenarios (Table 10). Small sliding sizes (e.g., 5000 and 8000) were found to result in an obvious overlap of benign and attack data and subsequently low recall. Larger sizes starting from 10,000 give a good separation. Increasing the sliding window size further from 10,000 trivially improves the recall and slightly lifts the FPR. Thus, 10,000 was selected as the default size.

TABLE 9
Comparison of reconstruction sizes on attack scenarios.

| | | | Input size 5 | | | |
|---|---|---|---|---|---|---|
| | Input size 3 | | (default) | | Input size 8 | |
| Host | Recall | FPR | Recall | FPR | Recall | FPR |
| 0051 | 0.896 | 0.017 | 1.000 | 0.005 | 0.984 | 0.006 |
| 0501 | 0.954 | 0.056 | 0.971 | 0.000 | 0.973 | 0.000 |
| 0660 | 1.000 | 0.038 | 1.000 | 0.019 | 1.000 | 0.029 |
| 0201 | 0.887 | 0.107 | 0.979 | 0.095 | 1.000 | 0.081 |
| avg | 0.934 | 0.054 | 0.988 | 0.030 | 0.989 | 0.029 |

TABLE 10
Comparison of sliding window sizes on attack scenarios.

| | |
|---|---|
| Host 0051 | Host 0501 |

| Sliding size | Recall | FPR | Recall | FPR |
|---|---|---|---|---|
| 5000 | 0.102 | 0.006 | 0.670 | 0.000 |
| 8000 | 0.542 | 0.000 | 0.895 | 0.034 |
| 10000 (default) | 1.000 | 0.005 | 0.971 | 0.000 |
| 15000 | 1.000 | 0.029 | 0.956 | 0.035 |
| 20000 | 1.000 | 0.012 | 0.998 | 0.024 |

State score calculation. A few alternative methods were explored for calculating the state scores. An alternative way of normalizing the frequency is to divide each attribute's frequency by the total number of entries in its category.

$$freq = \frac{\# occurrences of {attribute}_{i}}{\# entries in this category} \qquad ( 10 )$$

where length of window=Σⱼ #entries in categoryⱼ. This setting is referred to as categorical normalization.

For state score calculation, besides using the single attributes, alternatives were investigated using joint attribute distributions with two or three attributes. Formulas used in these alternative methods are discussed below. A score using a joint distribution for two attributes is calculated as

$$score = 1 - P ( {μ}_{1} - {diff}_{1} < {X}_{1} < {μ}_{1} + {diff}_{1} , {μ}_{2} - {diff}_{2} < {X}_{2} < {μ}_{2} + {diff}_{2} ) \qquad ( 11 )$$

where diff1 is the difference between the distribution mean μ1 for the first attribute and the newly observed data point d1 for the first attribute, similarly for diff2:

$${diff}_{1} = \vert {μ}_{1} - {d}_{1} \vert , {diff}_{2} = \vert {μ}_{2} - {d}_{2} \vert \qquad ( 12 )$$

$$and {F}_{{X}_{1} , {X}_{2}} , is the CDF of {X}_{1} , {X}_{2} : {F}_{{X}_{1} {X}_{2}} ( {x}_{1} , {x}_{2} ) = P ( {X}_{1} \leq {x}_{1} , {X}_{2} \leq {x}_{2} ) = {\int }_{- ∞}^{{x}_{1}} {\int }_{- ∞}^{{x}_{2}} {f}_{{X}_{1} , {X}_{2}} ( u , v ) dvdu \qquad ( 13 )$$

$$and {f}_{X} is the PDF of {X}_{1} , {X}_{2} : f ( x ; μ , \sum ) = \frac{1}{\sqrt{{( 2 π )}^{2} det ( \sum )}} exp ( - \frac{1}{2} {( x - μ )}^{T} {\sum }^{- 1} ( x - μ ) ) \qquad ( 14 )$$

with x being the vector for newly observed values ([d₁, d₂] in this case), μ being the vector for distribution mean, Σ being the covariance matrix, det(Σ) being the determinant of the covariance matrix. Using the joint distribution of multiple variables results in an increase in the dimensions of the score vector relative to using single variable distribution. That is, when considering all possible joint distributions of k variables chosen from the n behavior attributes from the previous step, the dimension of the score vector computes as

$$dimension = C ( n , k ) = ( \begin{matrix}n \\ k\end{matrix} ) = \frac{n !}{k ! ( n - k ) !} \qquad ( 15 )$$

where n is the number of selected attributes and k. For instance, in the case that we have 12 behavior attributes and employ joint distributions of 2 variables for score calculation, the score vectors will have a dimension of 66. The details for the joint distribution of 3 attributes are omitted here but the same procedure is followed.

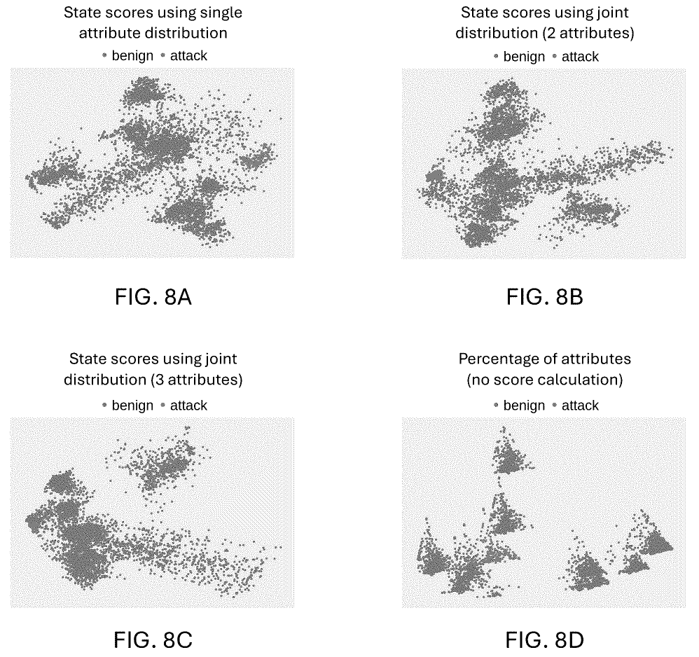

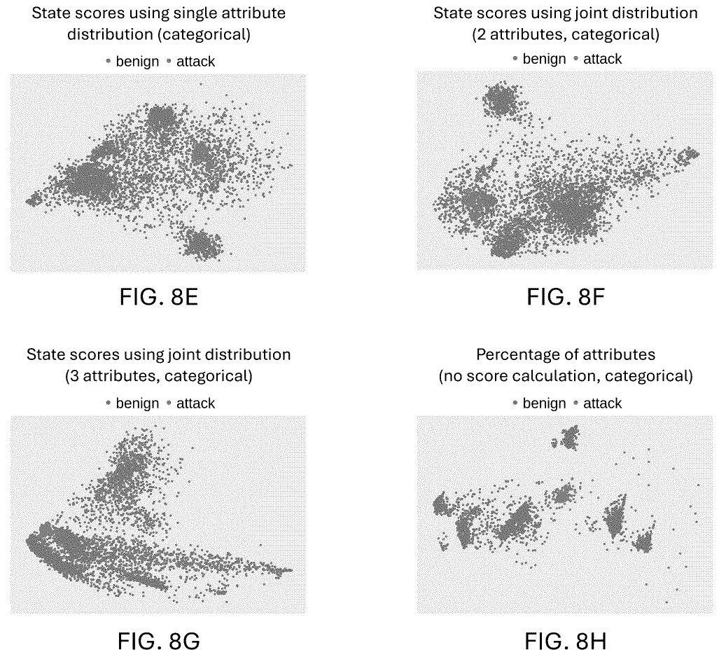

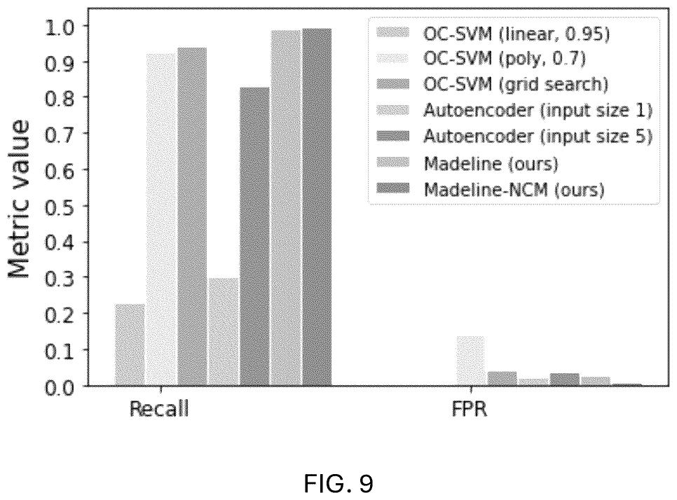

The distribution of benign and attack scores calculated by various methods was visualized using a PCA analysis (FIGS. 8A-H). Scores calculated using the default normalization and single attribute distribution show the best separation between benign and attack data (FIG. 8A). Scores calculated using the default normalization and joint distribution of multiple attributes also show good separation, with some overlap on the boundary (FIGS. 8B-C). Attack data points lay in the middle of benign points when using normalized frequencies without state score calculation (FIGS. 8D and 8H). Scores calculated based on categorical frequencies (FIGS. 8E, 8F, and 8G) exhibit large overlap between benign and attack data.

Moreover, calculating joint distribution requires significantly more time than calculating single attribute distribution (23% slower for 2 attributes and 58 times slower for 3 attributes on average). Therefore, scores based on single attribute distribution were used for the method.

Anomaly detection model. The efficacy of one-class support vector machine (OC-SVM) and autoencoder was tested as the anomaly detection model. The autoencoder evaluated in this section is a regular one without LSTM layers. The average performance on the four attacked hosts from the DARPA OpTC dataset are shown.

For OC-SVM, it was found that no single setup works for all scenarios. Detailed results are shown in Table 12. Using a linear kernel function and setting the hyperparameter nu at 0.95, the model performs well on Host 0051 but does not achieve this success across other hosts. A similar pattern is observed with other fixed configurations. A grid search of 76 configurations was further conducted to confirm this pattern. The 76 models are all possible combinations of 4 kernel functions (radial basis function (rbf), linear function, polynomial function, and sigmoid function) and a nu value from 0.05 to 0.95 with a 0.05 increment. Although there is at least one configuration that performs well on each attack scenario, the fatal issue is that attack knowledge is required to select a model with good recall. In a realistic setting, attack data is unlikely to be available at the model development stage.

TABLE 12
Performance of OC-SVM on attack scenarios as a baseline.

| | Fixed (linear, 0.95) | | Fixed (poly, 0.7) | | Grid search | |
|---|---|---|---|---|---|---|
| Host | Recall | FPR | Recall | FPR | Recall | FPR |
| 0051 | 0.929 | 0.006 | 1.000 | 0.455 | 0.929 | 0.006 |
| 0501 | 0.000 | 0.000 | 0.904 | 0.033 | 0.904 | 0.033 |
| 0660 | 0.000 | 0.000 | 0.940 | 0.075 | 0.950 | 0.094 |
| 0201 | 0.000 | 0.000 | 0.860 | 0.000 | 0.983 | 0.043 |
| avg | 0.232 | 0.002 | 0.926 | 0.141 | 0.942 | 0.044 |

For the autoencoder, performance is tested using an input size of 1 (i.e., one time window) and an input size of 5 (i.e., 5 consecutive windows). Table 13 shows the results. Input size 1 yields a recall of only 0.30 and input size 5 improves it to 0.83. The low performance of autoencoder could be because of its incapability of handling time sequence time, capturing irrelevant associations among random input elements yet failing to learn the crucial temporal relationships between scores.

TABLE 13
Performance of Autoencoder on attack scenarios as a baseline.

| | |
|---|---|
| Input size 1 | Input size 5 |

| Host | Recall | FPR | Recall | FPR |
|---|---|---|---|---|
| 0051 | 0.352 | 0.006 | 0.787 | 0.000 |
| 0501 | 0.566 | 0.022 | 0.862 | 0.000 |
| 0660 | 0.283 | 0.019 | 0.871 | 0.087 |
| 0201 | 0.004 | 0.052 | 0.797 | 0.069 |
| avg | 0.301 | 0.025 | 0.829 | 0.039 |

Madeline effectively detects all 3 APT scenarios on 4 different hosts from the DARPA OpTC dataset, with a recall of 0.988 and a FPR as low as 0.03.

Madeline-NCM further enhances the detection recall and reduces the FPR in all scenarios. Specifically, it lowers the FPR by 63% for the detection on the DARPA OpTC dataset.

As a lightweight real-time detection, Madeline is remarkably more time- and resource-efficient than graph-based solutions, achieving over 1000× reduction on processing time and 5× reduction in memory usage while showing comparable detection effectiveness to that of state-of-the-art.

Madeline's anomaly detection model LSTM autoencoder outperforms other baseline models. It outperforms the best OC-SVM and autoencoder by 5% and 19%, respectively, in terms of recall. It also shows 32% and 23% lower FPR when compared with these two baselines.

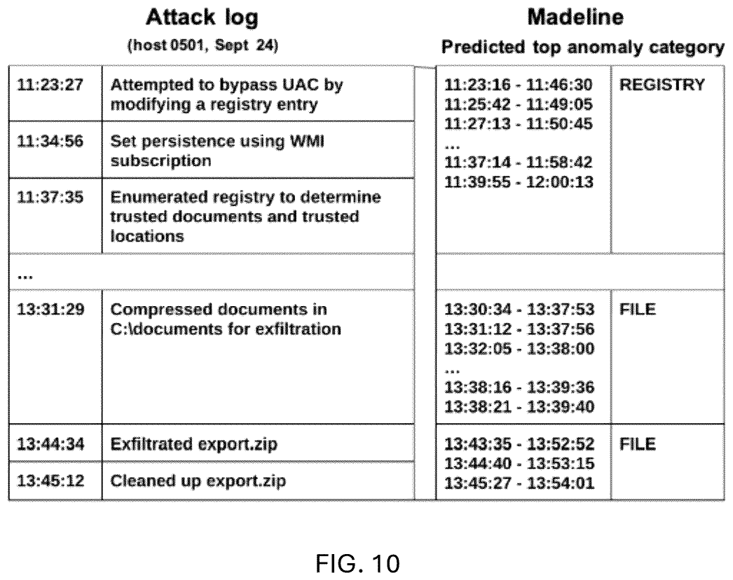

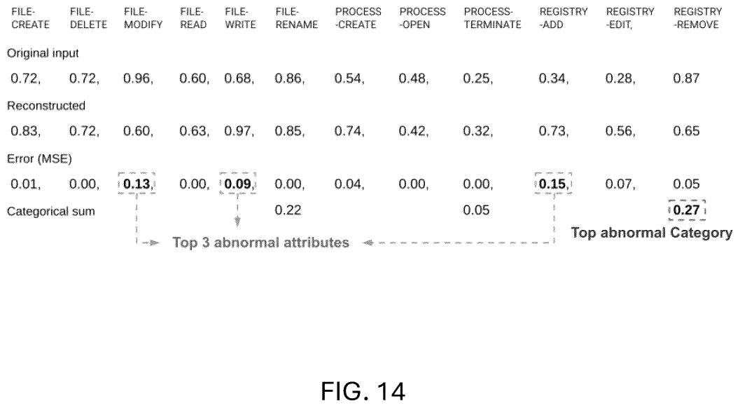

Prediction explainability. Beyond simply making a binary decision on each time window, Madeline also offers insights into explaining potential malicious behaviors observed. Our explainability operation is as follows. First, we infer the top abnormal attributes (e.g., registry-add) by inspecting the individual reconstruction error of each attribute (FIG. 14). Second, for all the attributes within a category (e.g., registry), we compute the summation of their reconstruction errors to obtain the category-level error (FIG. 14) and identify the category that has the highest error (e.g., registry category in FIG. 14). Third, we repeat this process for the subsequent time windows and use the results to obtain a sequence of high-error categories, e.g., [process→registry→file]. This sequence helps provide the dynamics of the potential attack behaviors. Fourth, we compare this sequence against known attack patterns to identify potential threats. For instance, a sequential pattern of [process→registry→file] might indicate suspicious processes being created for persistence establishment and file manipulation. For example, FIG. 10 correlates the identified top abnormal categories with ground truth attack behaviors on host 0501 from the DARPA OpTC dataset. The top abnormal category is registry when the red team attempted to modify the registry and establish persistence. When data exfiltration occurred, the file category was identified as the most abnormal. Security analysts can utilize this information and focus on top abnormal behaviors, thereby enhancing efficiency. The predictions and the actual attack may not be always aligned. One possible reason is the slight misalignments between the attack records logged by the red team and the system logs collected by other teams, while another reason could be the statistical model needs the logs to accumulate to a detectable state change.

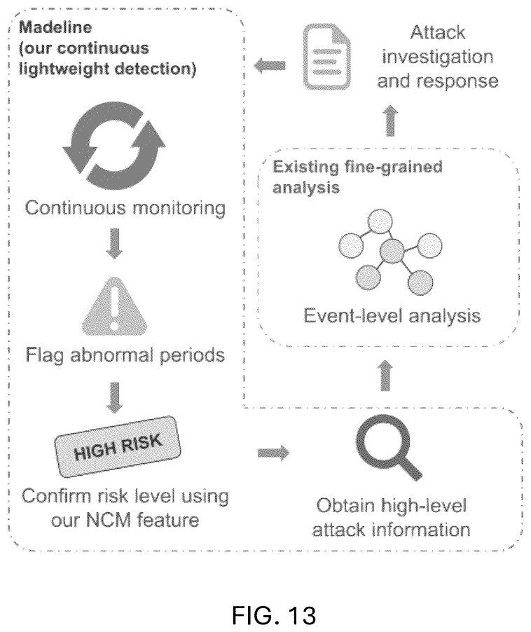

Use scenario. In addition to being effective as a standalone detection system, Madeline can serve as an initial layer of defense within a comprehensive APT investigation and response framework, complementing more detailed attack analyses. FIG. 13 presents an overview of the entire investigation workflow. Once a risk is verified, high-risk periods can be forwarded to further inspection through entity- and event-level log analyses (such as graph-based (Cheng, 2024) and embedding-based (Ding, H. et al. 2023, AIRTAG: Towards Automated Attack Investigation by Unsupervised Learning with Log Texts. In 32nd USENIX Security Symposium (USENIX Security 23) 373-390) analyses) to precisely identify attack activities and reconstruct the attack story. This helps better allocate investigative efforts for genuine high-risk time.

Model choices. LSTM autoencoder was selected as the anomaly detection model, despite the existence of more sophisticated sequential models, such as Transformer-based models. The reason is that one major advantage of those large models is their ability to learn token embedding based on the context. However, the statistical model already encapsulates the relationship between current and historical system states within the score vector. Additional context learning might not offer substantial benefits and could potentially disrupt the scores. Additionally, our goal is to develop a lightweight real-time detection. Large models, with significantly more parameters, may require considerably longer training and prediction, affecting the efficiency of monitoring.

Concept drift and model updating. System behaviors may change over time when new tasks are introduced, leading to an increase in false alarms. Madeline can be retrained and updated quickly within a few seconds, enabling a regularly based (e.g., daily) update of the model. Once it is confirmed that the risk associated with a specific time period is low, the data from this period can be utilized to update the anomaly detection model. The integrity of benign logs used for training was assumed. Although the detection of data poisoning is an important field to research, it is beyond the scope of this study.

Limitations. Regarding dataset choices, the evaluation was constrained due to the mixture of attack and benign data in some datasets, such as the popular DARPA Transparent Computing (TC) dataset. As an unsupervised learning framework, Madeline needs attack-free data for training. Because of the substantial overlap of attack and benign traces, removing attack entries from the log inevitably affects the statistics of benign behaviors and thus fails to reflect a real-world benign setting. While event-level analyses can precisely remove attack edges and exclude abnormal interactions, the coarse-grained detection may be influenced implicitly by the distorted statistic.

Similar to other detection systems, Madeline's efficacy may be affected by finely crafted, sophisticated mimicry attacks that disguise themselves as benign activities (Dai, H. et al., 2018. Adversarial attack on graph structured data. In International conference on machine learning. PMLR, 1115-1124; Goyal, A. et al., 2023, Sometimes, you aren't what you do: Mimicry attacks against provenance graph host intrusion detection systems. In 30th Network and Distributed System Security Symposium; Wagner, D. and Soto, P., 2002, Mimicry attacks on host-based intrusion detection systems. In Proceedings of the 9th ACM Conference on Computer and Communications Security. 255-264). However, such evasive attacks require significant effort to acquire historical system knowledge, calculate a seemingly benign behavior ratio, and make adjustments with consideration of the ongoing background system activities. Additionally, Madeline may struggle to generalize to unseen or unknown benign behaviors. That is, models trained on the historical data of one host may not perform well on another host with different behaviors.

The present invention is described with reference to particular embodiments having various features. In light of this disclosure, it will be apparent to those skilled in the art that various modifications and variations can be made in the practice of the present invention without departing from the scope or spirit of the invention. One skilled in the art will recognize that the disclosed features may be used singularly, in any combination, or omitted based on the requirements and specifications of a given application or design. When an embodiment refers to “comprising” certain features, it is to be understood that the embodiments can alternatively “consist of” or “consist essentially of” any one or more of the features. Any of the methods disclosed herein can be used with any of the systems disclosed herein or with any other systems. Likewise, any of the disclosed systems can be used with any of the methods disclosed herein or with any other methods. Other embodiments of the invention will be apparent to those skilled in the art from consideration of the specification and practice of the invention.

It is noted in particular that where a range of values is provided in this specification, each value between the upper and lower limits of that range is also specifically disclosed. The upper and lower limits of these smaller ranges may independently be included or excluded in the range as well. The singular forms “a,” “an,” and “the” include plural referents unless the context clearly dictates otherwise. It is intended that the specification and examples be considered as exemplary in nature and that variations that do not depart from the essence of the invention fall within the scope of the invention. Further, all of the references cited in this disclosure are each individually incorporated by reference herein in their entireties and as such are intended to provide an efficient way of supplementing the enabling disclosure of this invention as well as provide background detailing the level of ordinary skill in the art.

1. A method of monitoring computer activity comprising:
performing distribution-based system state embedding on one or more attributes related to computer activity;
training an anomaly detection machine learning model with the system state embedding;
detecting one or more anomaly related to the computer activity; and
reporting a threat relating to the one or more anomaly.

2. The method of claim 1, further comprising:
categorizing audit log entries by one or more attributes, each comprising an action and an object, related to the computer activity;
identifying a window comprising selected audit log entries and selected attributes;
calculating frequencies for the selected attributes; and
normalizing the calculated frequencies, wherein the normalized calculated frequencies of the selected attributes form a first frequency vector;
wherein the normalizing is performed by dividing a number of occurrences of the selected attribute by the length of the window.

3. The method of claim 2, further comprising:
computing a score for each of the selected attributes using historical data; and/or
computing additional frequency vectors for multiple windows; and
determining distributions of calculated frequencies from the first frequency vector and/or one or more of the additional frequency vectors.

4. The method of claim 2, further comprising:
obtaining a new frequency vector; and
calculating a probability score for the one or more attributes in the new frequency vector using a cumulative distribution function (CDF).

5. The method of claim 4, wherein the probability score is calculated as follows:
$$probability score = 1 - P ( μ - diff < X < μ + diff ) = 1 - ( {F}_{X} ( μ + diff ) - {F}_{X} ( μ - diff ) )$$
wherein:
X represents the distribution;
μ is the distribution mean;
diff is the difference between μ and a newly observed data point d;
F_{X} is the CDF of X, calculated as
$${F}_{X} ( x ) = P ( X \leq x ) = {\int }_{- ∞}^{x} {f}_{X} ( t ) dt ;$$
f_{X} is the probability density function (PDF) of X, calculated as
$${f}_{X} ( x ; μ , σ ) = \frac{1}{σ \sqrt{2 π}} {e}^{- \frac{1}{2} {( \frac{x - μ}{σ} )}^{2}} ;$$
and
σ is the standard deviation.

6. The method of claim 4, wherein:
the calculated probability scores form one or more system state score vectors;
one or more system state score vectors are used to train the anomaly detection model; and
the one or more anomaly is identified using the anomaly detection model.

7. The method of claim 6, wherein the anomaly detection model comprises a self-reconstruction model trained by:
reading one or more system state score vectors;
encoding one or more system state score vectors;
decoding the encoded one or more system state score vectors; and
reconstructing the one or more system state score vectors.

8. The method of claim 6, wherein the anomaly detection model comprises an LSTM autoencoder.

9. The method of claim 6, wherein the anomaly detection model comprises a next-step reconstruction model trained to use a decoder to predict a system state for subsequent time windows using the one or more system state score vectors.

10. The method of claim 6, wherein the anomaly detection model comprises a composite model configured to use a first decoder to reconstruct the one or more system state score vectors and a second decoder to predict a system state for subsequent time windows using the one or more system state score vectors.

11. The method of claim 1, wherein the anomaly detection model is trained by encoding and learning system states from an infinite combination of behaviors.

12. The method of claim 1, further comprising interpreting predicted system states to detect anomalies.

13. The method of claim 10, further comprising:
minimizing the difference between one or more reconstructed vectors and one or more target vectors; and/or
calculating mean absolute error between the one or more reconstructed vectors and one or more target vectors.

14. The method of claim 13, further comprising determining the mean absolute error for m time windows with n features as follows:
$$M A {E}_{m} = {{\sum }_{i = 1}}^{m} \frac{1}{n} {{\sum }_{j = 1}}^{n} \vert {t}_{ij} - {r}_{ij} \vert$$
wherein tᵢⱼ represents the jth element in the ith time window for the one or more target vectors; and
wherein rᵢⱼ represents the jth element in the ith time window for the one or more reconstructed vectors.

15. The method of claim 14, wherein:
if the calculated mean absolute error exceeds a pre-determined threshold, then the window is flagged as abnormal; or
if the calculated mean absolute error does not exceed the pre-determined threshold, then the window is labeled as normal.

16. The method of claim 15, wherein the pre-determined threshold is selected to be two standard deviations from the distribution mean following the 68-95-99 rule.

17. The method of claim 1, wherein the method is capable of providing neighbor-based continuous monitoring.

18. The method of claim 17, wherein for a target window wᵢ and a neighbor size b, the decision for the target window is determined as follows:
$${D}_{NCM} ( {w}_{i} ) = mode \{ D ( {w}_{i + k} ) \vert k ∈ [ - b , b ] , 0 ⩽ i + k ⩽ e \}$$
wherein e is the ending index of currently available predictions.

19. A method of identifying a potential cyber threat, the method comprising:
performing distribution-based system state embedding on one or more attributes related to a selected time window of computer activity;
determining and comparing a system state score vector and a reconstructed system state score vector for one or more of the attributes to obtain an individual reconstruction error;
comparing the individual reconstruction errors of the attributes to determine top abnormal attributes and identifying a category of each top abnormal attribute;
determining one or more category-level error by performing a summation of the individual reconstruction errors within each category and identifying the category with the highest error;
repeating the determining, comparing, identifying and summation steps for one or more additional or subsequent time window;
determining a sequence of the highest error categories, thereby identifying dynamics of potential cyber threat behaviors; and
comparing the sequence of the highest error categories against one or more known cyber threat pattern to identify potential cyber threats.

20. A system comprising:
a memory for storing computer-executable instructions and for storing a trained distribution-based statistical machine learning model;
a computer processor for executing the computer-executable instructions, wherein the computer-executable instructions are configured to detect one or more anomaly related to computer activity using the trained distribution-based statistical machine learning model;
wherein the trained distribution-based statistical machine learning model is trained using distribution-based system state embedding on one or more attributes related to the computer activity and system state score vectors derived from the system state embedding.
